(19) United States
(12) Patent Application Publication
(10) Pub. No.: US 2025/0056524 A1
(43) Pub. Date: Feb. 13, 2025

(54) COMMUNICATION CONTROL METHOD

(71) Applicant: KYOCERA Corporation, Kyoto (JP)

(72) Inventor: Masato FUJISHIRO, Yokohama-shi (JP)

(73) Assignee: KYOCERA Corporation, Kyoto (JP)

(21) Appl. No.: 18/928,693

(22) Filed: Oct. 28, 2024

Related U.S. Application Data
(63) Continuation of application No. PCT/JP2023/016511, filed on Apr. 26, 2023.

(30) Foreign Application Priority Data
Apr. 27, 2022 (JP) 2022-073809

(51) Int. Cl. H04W 72/11

(52) U.S. Cl. CPC H04W 72/11

(57) ABSTRACT

A communication control method according to one aspect is a communication control method in a mobile communication system. The communication control method includes performing, at a base station, one of associating a first Semi-Persistent Scheduling (SPS) configuration and a second SPS configuration having different periodicities, or associating a first Configured Grant (CG) configuration and a second CG configuration having different periodicities. The communication control method includes transmitting, at the base station, first association information to a user equipment, the first association information relating to one of the association between the first SPS configuration and the second SPS configuration or the association between the first CG configuration and the second CG configuration.

### RELATED APPLICATIONS

The present application is a continuation based on PCT Application No. PCT/JP2023/016511, filed on Apr. 26, 2023, which claims the benefit of Japanese Patent Application No. 2022-073809 filed on Apr. 27, 2022. The content of which is incorporated by reference herein in their entirety.

### TECHNICAL FIELD

The present disclosure relates to a communication control method in mobile communication systems.

### BACKGROUND

In specifications of the Third Generation Partnership Project (3GPP) (registered trademark. The same applies below) that is a standardization project for mobile communication systems, extended Reality (XR) has been approved for Release 18. XR is a broad term that includes Virtual Reality (VR), Augmented Reality (AR), and Mixed Reality (MR), and represents an environment obtained by merging a real world and a virtual space. XR represents a mixed environment of a real space and a virtual space generated by computer technology and wearable devices, and expresses an interaction between a human and a machine.

### CITATION LIST

### Non-Patent Literature

Non-Patent Document 1: RP-213587, 3GPP TSG RAN Meeting #94e, “Study on XR Enhancements for NR”, Nokia, Dec. 6-17, 2021.

Non-Patent Document 2: 3GPP TR 38.838 V17.0.0 (2021-12)

### SUMMARY

A communication control method according to one aspect is a communication control method in a mobile communication system. The communication control method includes performing, at a base station, one of associating a first Semi-Persistent Scheduling (SPS) configuration and a second SPS configuration having different periodicities or associating a first Configured Grant (CG) configuration and a second CG configuration having different periodicities. The communication control method includes transmitting, at the base station, first association information to a user equipment, the first association information relating to one of the association between the first SPS configuration and the second SPS configuration or the association between the first CG configuration and the second CG configuration.

A communication control method according to one aspect is a communication control method in a mobile communication system. The communication control method includes configuring, at a base station, an SPS configuration or a CG configuration for a user equipment. The communication control method includes transmitting, at a base station to a user equipment, a timing adjustment command for adjusting a start timing of a periodicity indicated by the SPS configuration or the CG configuration.

### BRIEF DESCRIPTION OF THE DRAWINGS

FIG. 1 is a diagram illustrating a configuration example of a mobile communication system according to a first embodiment.

FIG. 2 is a diagram illustrating a configuration example of a user equipment (UE) according to the first embodiment.

FIG. 3 is a diagram illustrating a configuration example of a gNB (base station) according to the first embodiment.

FIG. 4 is a diagram illustrating a configuration example of a protocol stack for a user plane according to the first embodiment.

FIG. 5 is a diagram illustrating a configuration example of a protocol stack for a control plane according to the first embodiment.

FIG. 6 is a diagram illustrating an operation example according to the first embodiment. FIGS. 7A and 7B are diagrams illustrating an example of a relationship between traffic periodicity and CG periodicity according to the first embodiment.

FIG. 8 is a flowchart illustrating an operation example according to a second embodiment.

### DESCRIPTION OF EMBODIMENTS

An aspect of the present disclosure provides a communication control method that can appropriately perform communication using XR.

A mobile communication system according to an embodiment is described with reference to the drawings. In the description of the drawings, the same or similar parts are denoted by the same or similar reference signs.

First Embodiment Configuration of Mobile Communication System

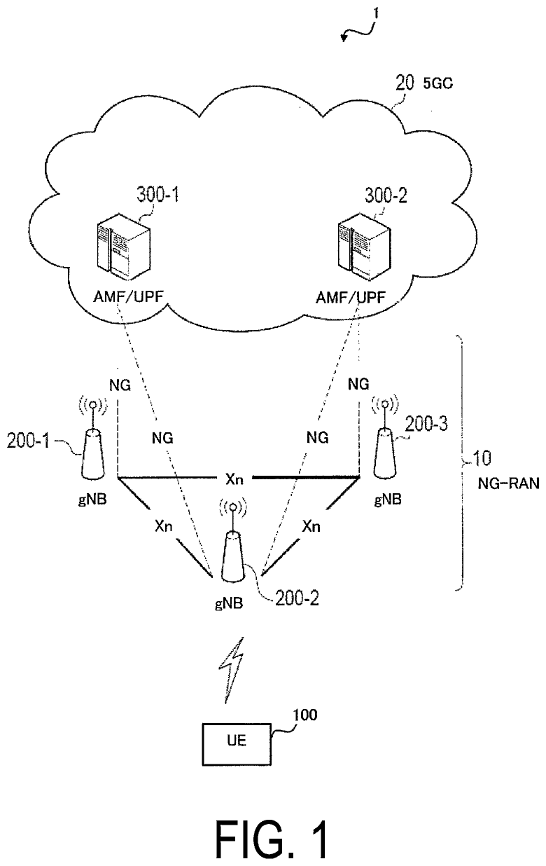

FIG. 1 is a diagram illustrating a configuration of a mobile communication system according to a first embodiment. The mobile communication system 1 complies with the 5th Generation System (5GS) of the 3GPP standard. The description below takes the 5GS as an example, but Long Term Evolution (LTE) system may be at least partially applied to the mobile communication system. Alternatively, a sixth generation (6G) system may be at least partially used for the mobile communication system.

The mobile communication system 1 includes a User Equipment (UE) 100, a 5G radio access network (Next Generation Radio Access Network (NG-RAN)) 10, and a 5G Core Network (5GC) 20. The NG-RAN 10 may be hereinafter simply referred to as a RAN 10. The 5GC 20 may be simply referred to as a core network (CN) 20.

The UE 100 is a mobile wireless communication apparatus. The UE 100 may be any apparatus as long as the UE 100 is used by a user. Examples of the UE 100 include a mobile phone terminal (including a smartphone) or a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The UE 100 includes an XR device. The XR device is, for example, a device that can process XR. More specifically, the XR device includes a Head Mount Display (HMD) that can be mounted on a head of a person, an eyeglass-type AR glass (or smart glass), a mobile handset that can be held by a hand, a wristwatch-type device (smartwatch), and a smartphone. These XR devices may be referred to as wearable devices. The HMD includes a display, a lens, a tracking sensor, a camera, a control unit (such as a Central Processing Unit (CPU) or a Graphics Processing Unit (GPU)) that performs processing related to the XR, and a communication function. The AR glass has a function of allowing a video to transmit therethrough. The mobile handset may include various sensors such as tracking sensors. The HMDs, the AR glasses, the wristwatch-type devices, and the mobile handsets have communication functions that support the 5G systems and the like. Hereinafter, the UE 100 will be described assuming that the UE 100 includes such an XR device.

The NG-RAN 10 includes base stations (referred to as “gNBs” in the 5G system) 200. The gNBs 200 are interconnected via an Xn interface, which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter simply referred to as one “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface, which is an interface between a base station and the core network.

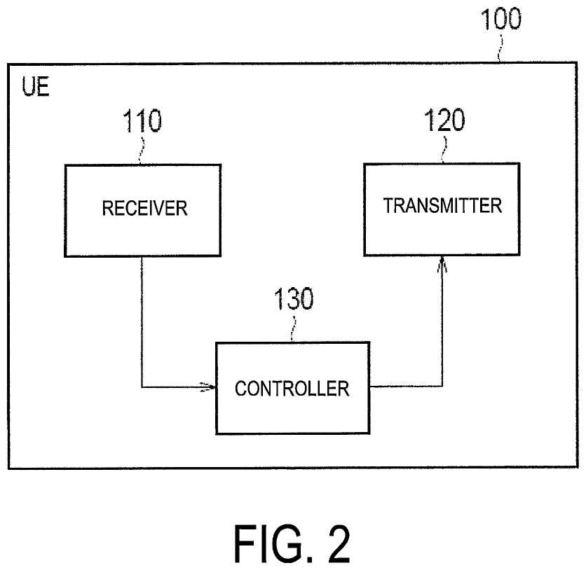

FIG. 2 is a diagram illustrating a configuration of the user equipment (UE) 100 according to the first embodiment. The UE 100 includes a receiver 110, a transmitter 120, and a controller 130. The receiver 110 and the transmitter 120 constitute a wireless communicator that performs wireless communication with the gNB 200.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processing in the UE 100. Such processing includes processing of respective layers to be described later. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing. Note that the controller 130 may perform each processing and each operation in the UE 100 in each embodiment to be described below.

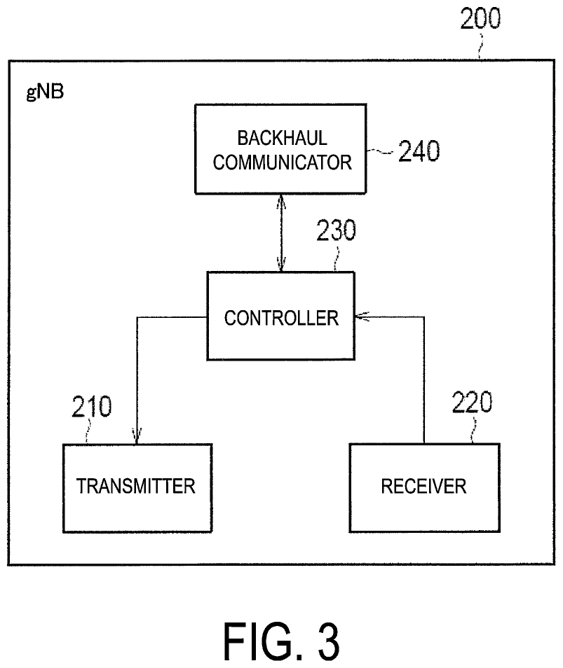

FIG. 3 is a diagram illustrating a configuration of the gNB 200 (base station) according to the first embodiment. The gNB 200 includes a transmitter 210, a receiver 220, a controller 230, and a backhaul communicator 240. The transmitter 210 and the receiver 220 constitute a wireless communicator that performs wireless communication with the UE 100. The backhaul communicator 240 constitutes a network communicator that performs communication with the CN 20.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processing in the gNB 200. Such processing includes processing of respective layers to be described later. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. Note that the controller 230 may perform all of the processing and operations in the gNB 200 in each embodiment to be described below.

The backhaul communicator 240 is connected to a neighboring base station via an Xn interface, which is an inter-base station interface. The backhaul communicator 240 is connected to the AMF/UPF 300 via a NG interface between a base station and the core network. Note that the gNB 200 may include a Central Unit (CU) and a Distributed Unit (DU) (i.e., functions are divided), and the two units may be connected via an F1 interface, which is a fronthaul interface.

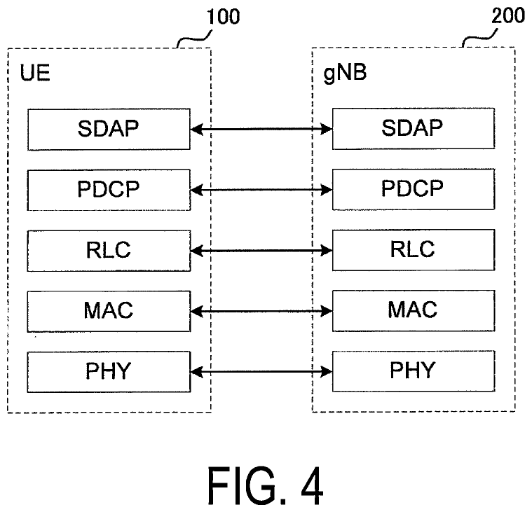

FIG. 4 is a diagram illustrating a configuration of a protocol stack of a radio interface of a user plane handling data.

A radio interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 blind decodes the PDCCH using a radio network temporary identifier (RNTI) and acquires successfully decoded DCI as DCI addressed to the UE 100. The DCI transmitted from the gNB 200 is appended with CRC parity bits scrambled by the RNTI.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QOS) control performed by a core network and a radio bearer as the unit of QoS control performed by an Access Stratum (AS). Note that, when the RAN is connected to the EPC, the SDAP need not be provided.

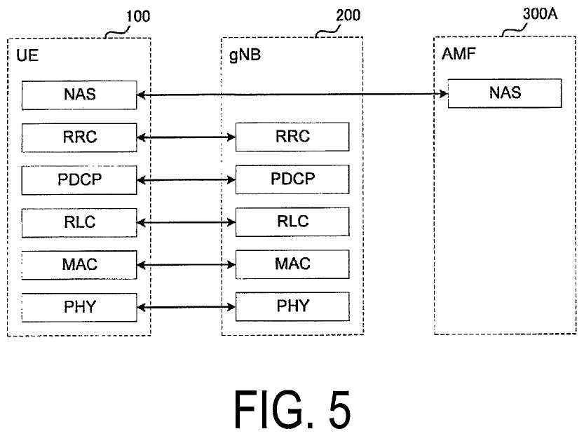

FIG. 5 is a diagram illustrating a configuration of a protocol stack of a radio interface of a control plane handling signaling (a control signal).

The protocol stack of the radio interface of the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS, which is positioned upper than the RRC layer, performs session management, mobility management, and the like. NAS signaling is transmitted between the NAS of the UE 100 and the NAS of the AMF 300. Note that the UE 100 includes an application layer other than the protocol of the radio interface. A layer lower than the NAS is referred to as Access Stratum (AS).

### XR

As described above, XR is a broad term that includes, for example, Virtual Reality (VR), Augmented Reality (AR), and Mixed Reality (MR) and represents an environment obtained by merging a real world and a virtual space. XR is also, for example, a generic term for such various types of realities. XR is also, for example, a generic term for a technology that enables perception of something that does not exist in reality by, for example, merging the real world and the virtual space.

According to XR, the UE 100 that is a portable or wearable end-user device assists human-to-machine or human-to-human communication to execute. Such communication enables application of XR to various application fields such as entertainment, healthcare, or education.

In addition to XR, Cloud Gaming (CG) is one of use cases in future mobile systems. Cloud gaming is, for example, a generic term for use cases where most of computation related to a game is offloaded to an edge server or a remote server. According to cloud gaming, the UE 100 transmits information related to pose and/or control. A cloud side performs computation and the like related to video data or the like based on these pieces of information, and provides videos and the like related to the game to the UE 100.

Note that Virtual Reality (VR) refers to creating an environment that is not an original (or a real world), yet whose functional essence is the same as the original by stimulating a user's sense. According to Virtual Reality (VR), a user generally wears an HMD, the user's field of view is replaced with simulated visual elements, and accompanying audios are provided to the user through a headphone. The virtual space is designed to mimic sensory stimulation of a visual sense, an auditory sense, or the like of the real world as naturally as possible. Metaverse that is a virtual space (or service) constructed in a computer or a computer network and is different from the real world may be also included in Virtual Reality (VR).

Augmented Reality (AR) is, for example, a technique of superimposing a virtual space on the real world to display. Augmented Reality (AR) also provides additional information (artificially generated items or content) by superimposing the additional information on an environment of user's reality. The additional information may be also directly perceived without a sensor or the like, or indirectly perceived via a sensor or the like.

Mixed Reality (MR) is a technique that mixes and/or merges, for example, a real world and a virtual space to construct spaces that influence each other in real time. Mixed Reality (MR) is a development form of Augmented Reality (AR) and is constructed with the intention of inserting virtual elements into a physical scene and giving an illusion that the virtual elements are part of an actual scene.

Representative forms of XR are Virtual Reality (VR), Augmented Reality (AR), and Mixed Reality (MR), and XR includes fields for interpolating between these VR, AR, and MR, too.

In many use cases of XR and Cloud Gaming (CG), a DL direction is characterized by video stream traffic and a UL direction is characterized by traffic that is a combination of pose and/or control and a video stream. The video stream also has a feature that the video stream has a relatively high data rate, and data related to pose and/or control is frequently updated. XR and Cloud Gaming (CG) also have a feature that traffic in the DL direction and traffic in the UL direction are traffic that are strict against delay as compared to other use cases.

### XR Traffic Models

Hereinafter, XR traffic models will be described. The XR traffic models include (1) general traffic models and (2) specific traffic models. First, (1) the general traffic models will be described. (1) The general traffic models include (1.1) traffic models in the DL direction and (1.2) traffic models in the UL direction.

### (1) General Traffic Models

(1.1) Traffic Models in DL direction

The traffic models in the DL direction include a single-stream DL traffic model and a multi stream DL traffic model. The two traffic models can be summarized as follows.

### (1.1.1) Single Stream DL Traffic Model: Series of Video Frames

(1.1.2) Multi Stream DL Traffic Model:
(1.1.2.1) Option #1: Two Streams of First Stream That Is Intra-Coded (I) Stream and Second Stream That Is Predicted (P) Stream. Option #1 includes a slice-based traffic model (option #1A) and a Group-Of-Picture (GOP)-based traffic model (option #1B).
(1.1.2.1A) Option #1A (slice-based): First Stream Is I Slice (I stream), and Second Stream Is P Slice (P stream). The I slice is, for example, a slice obtained by encoding all macroblocks included in the I slice by intra-frame prediction. The P slice is, for example, a slice obtained by encoding all macroblocks included in the P slice by intra-frame prediction or inter-frame prediction. When a video frame is sliced into N frames, one frame may be the I slice and the remaining (N−1) frames may be the P slices.

(1.1.2.1B) Option #1B (GOP-Based): First Stream Is I Frame (I Stream), and Second Stream Is P Slice (P Stream). The I frame is a frame encoded from the corresponding video frame without using another video frame. The P frame is a frame encoded using a video frame in a temporally forward direction. When a GOP size is K frames, the I frame is transmitted every K frames. The GOP includes the one I frame and the (K−1) P frames.
(1.1.2.2) Option #2: Traffic Model Includes Two Streams of First Stream That Is Video and Second Stream That Is Audio and/or Data.
(1.1.2.3) Option #3: Traffic Model Includes First Stream That Is Field of View (FOV) and Second Stream That Is Omnidirectional View. For example, the FOV is video data of a user's line of sight, and the omnidirectional view is video data of omnidirections that includes the video data of the user's line of sight and whose center is the user.

### (1.2) Traffic Models in UL Direction

The traffic models in the UL direction include pose and/or control stream traffic models. The traffic models are traffic models in which the UE 100 transmits data related to pose and/or control.

### (2) Specific Traffic Models

Specific traffic models include (2.1) a Virtual Reality (VR) traffic model, (2.2) an Augmented Reality (AR) traffic model, and (2.3) a Cloud Gaming (CG) traffic model.

### (2.1) Virtual Reality (VR) Traffic Model

The Virtual Reality (VR) traffic model can be summarized as follows.

(2.1.1) DL Stream:
Single Stream Model: Identical to Above (1.1.1) “Single Stream DL Traffic Model” (Series of Video Frames)
Multi Stream Model: Identical to Above (1.1.2.2) “Option #2” (First Stream Is Video and Second Stream Is Audio and/or Data)

(2.1.2) UL Stream: Identical to Above (1.2) “Traffic Model in UL Direction”.

### (2.2) Augmented Reality (AR) Traffic Model

The Augmented Reality (AR) traffic model can be summarized as follows.

(2.2.1) DL Stream: Identical to Above (2.1.1)

(2.2.2) UL Stream:
Model #1:1 Stream Model
Model #2:2 Stream Model: First Stream Is Pose and/or Control, and Second Stream Is Collection of Scene (e.g., Continuous Video), Video, Data, and Audio
Model #3A: 3 Stream Model A: First Stream Is Pose and/or Control, Second Stream Is One Stream of Collection of Stream of Scene and Stream of Video, and Third Stream Is One Stream of Collection of Audio and Data.
Model #3B: 3 Stream Model B: First Stream Is Pose and/or Control, Second Stream Is I Stream of Video, and Third Stream Is P Streams of Video

### (2.3) Cloud Gaming (CG) Traffic Model

The Cloud Gaming (CG) traffic model can be summarized as follows.

### (2.3.1) DL Stream

Single Stream Model: Identical to Above (1.1.1) “Single Stream DL Traffic Model” (Series of Video Frames)
Multi Stream Model: Identical to Above (1.1.2) “Multi Stream DL Traffic Model”

(2.3.2) UL Stream: Identical to Above (1.2) “Traffic Model in UL Direction”.

### SPS and CG

The 5G system may use a scheduling scheme that is called Semi-Persistent Scheduling (SPS) in the DL direction. SPS is a scheduling scheme where, when, for example, radio resources in the DL direction are allocated by Downlink Control Information (DCI) transmitted using a Physical Downlink. Control Channel (PDCCH), then the UE 100 becomes able to perform communication in the DL direction using the radio resources periodically without using the DCI. Unlike dynamic scheduling of performing scheduling using DCI for each Physical Downlink Shared Channel (PDSCH), SPS enables semi-static scheduling, so that the number of processing steps in the UE 100 can be reduced. Note that the UE 100 is notified of the periodicity by the gNB 200 through an SPS configuration (SPS-Config) included in an RRC message (e.g., an RRC setup (RRCSetup) message or an RRC reconfiguration (RRCReconfiguration) message). The gNB 200 can also configure a plurality of SPS configurations having different periodicities.

The 5G system may use a scheduling scheme that is called Configured Grant (CG) in the UL direction. CG is a scheduling scheme where, when, for example, radio resources in the UL direction are allocated by DCI transmitted using a PDCCH, then the UE 100 becomes able to perform communication in the UL direction using the radio resources periodically without using the DCI. The UE 100 is notified of the periodicity by the gNB 200 through a

CG configuration (ConfiguredGrantConfig) included in an RRC message (e.g., an RRC setup (RRCSetup) message or an RRC reconfiguration (RRCReconfiguration) message). Note that CG includes a type 1 (Type 1) that enables UL transmission without using DCI and a type 2(Type 2) that performs UL transmission using DCI. In a case of the type 1, the CG configuration directly includes radio resources. The gNB 200 can also configure a plurality of CG configurations having different periodicities.

### Communication Control Method According to First Embodiment

In the above-described XR traffic model, for example, the UL stream is indicated as a single stream model for transmitting traffic related to pose and/or control (above (1.2)). However, in reality, the UL stream is transmitted as a single stream including different traffic such as video data in addition to traffic related to pose and/or control. In a case of multi streams, different traffic is produced for each stream as indicated by the above-described XR traffic model.

Since such an XR traffic may have periodicity, the CG configuration and the SPS configuration that enable periodic transmission or reception are considered to be valid. It is assumed that UL transmission is performed using the CG configuration for the XR traffic.

In this case, when radio resources are allocated by the CG configuration assuming that the stream includes the traffic related to pose and/or control, the radio resources may be left over. On the other hand, when the radio resources are allocated by the CG configuration assuming that the stream includes video data traffic, the radio resources may become insufficient. When radio resources become insufficient, a plurality of CG configurations can be also used. However, according to the current specification, the CG configurations are independent, and what type of relationship the plurality of CG configurations have with each other cannot be configured. Although the CG configuration enables UL transmission by periodically using radio resources, video data traffic in the XR traffic may also occur non-periodically. Therefore, for example, the UE 100 may not be able to appropriately transmit the XR traffic using the CG configuration.

Similarly to a case where DL transmission is performed using the SPS configuration, too, radio resources may become surplus or radio resources may become insufficient. The UE 100 may not be able to appropriately receive non-periodically generated video data traffic.

As described above, since the XR traffic includes various traffic models, for example, the UE 100 may not be able to appropriately perform the XR traffic communication. Therefore, the mobile communication system 1 may not be able to appropriately perform communication using XR.

An object of the first embodiment is that the mobile communication system 1 appropriately performs communication using XR.

Hence, according to the first embodiment, a plurality of SPS configurations or a plurality of CG configurations are performed, and the plurality of SPS configurations or the plurality of CG configurations are associated.

More specifically, firstly, the base station (e.g., gNB 200) associates a first SPS configuration and a second SPS configuration having different periodicities, and associates a first CG configuration and a second CG configuration having different periodicities. Secondly, the base station transmits, to the user equipment (e.g., UE 100), first association information relating to one of the association between the first SPS configuration and the second SPS configuration or the association between the first CG configuration and the second CG configuration.

Thus, for example, the UE 100 recognizes that the first CG configuration and the second CG configuration are associated, and can transmit video data traffic having a higher data rate than other traffic or transmit non-periodic video data traffic by using the two configurations having different periodicities. For example, the UE 100 recognizes that the first SPS configuration and the second SPS configuration are associated, and can receive video data traffic having a higher data rate than other traffic or receive non-periodic video data traffic by using the two configurations having different periodicities. Accordingly, the mobile communication system 1 can appropriately perform communication that uses XR.

### Operation Example of First Embodiment

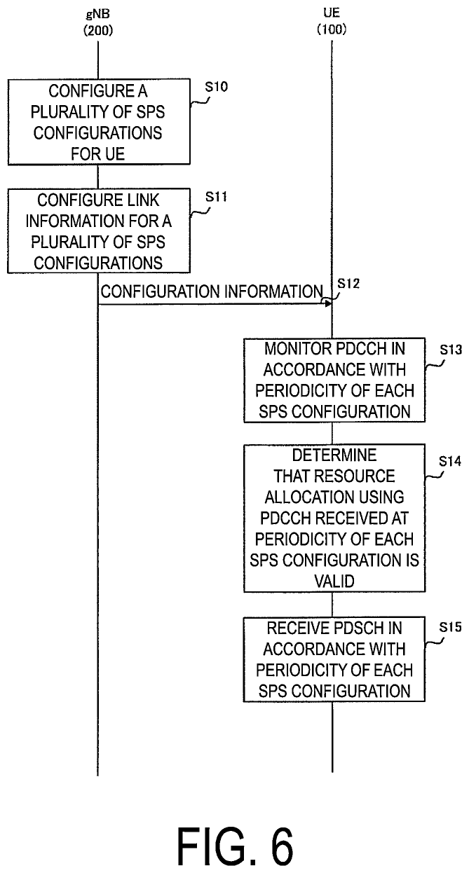

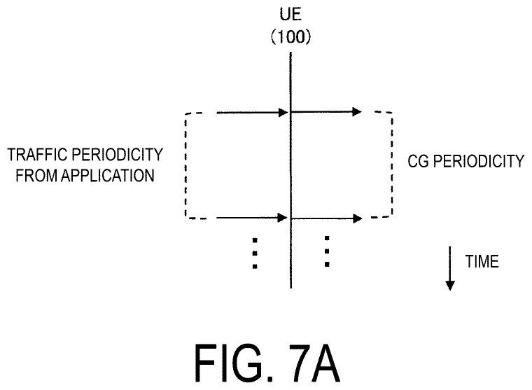

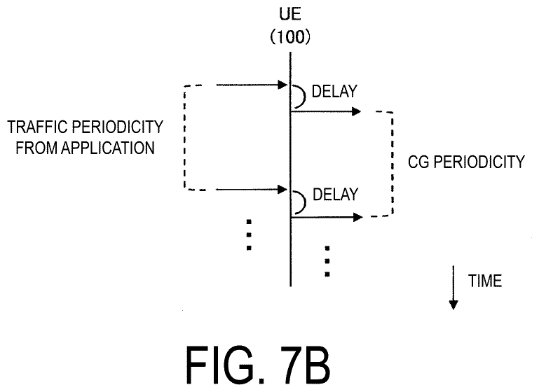

FIG. 6 is a flowchart illustrating an operation example of the first embodiment. Note that FIG. 6 illustrates an example of the SPS configuration. First, an example where a plurality of SPS configurations are associated will be described.

As illustrated in FIG. 6, the gNB 200 configures the plurality of SPS configurations having respectively different periodicities for the UE 100 in step S10. For example, the gNB 200 configures for the UE 100 the first SPS configuration of a first periodicity and the second SPS configuration of a second periodicity different from the first periodicity. As described above, the SPS configuration includes the periodicity. Note that each SPS configuration includes a different index value (sps-ConfigIndex). For example, the first SPS configuration includes an index #1, and the second SPS configuration includes the index #2.

In step S11, the gNB 200 associates the plurality of SPS configurations configured in step S10 and having the different periodicities, and configures association information relating to the association between the plurality of SPS configurations. For example, the gNB 200 associates the first SPS configuration and the second SPS configuration, and configures association information relating to the association between the first SPS configuration and the second SPS configuration. Association may be performed by, for example, associating the index #1 of the first SPS configuration and the index #2 of the second SPS configuration using an index value to configure the association information. The plurality of associated SPS configurations are recognized as a single SPS in the UE 100. When, for example, the index #1of the first SPS configuration and the index #2 of the second SPS configuration are associated, the two SPS configurations are recognized as a single SPS. On the other hand, when, for example, an index #3 and an index #4 are not associated, a third SPS configuration of the index #3 and a fourth SPS configuration of the index #4 are recognized as independent and different SPS configurations.

Note that the gNB 200 may further configure a plurality of CS-RNTIs for the UE 100. In this case, the gNB 200 may associate each SPS configuration with each CS-RNTI, and configure association information of each SPS configuration and each CS-RNTI. For example, the gNB 200 associates (the index #1 of) the first SPS configuration and a first CS-RNTI, and associates (the index #2 of) the second SPS configuration and a second

CS-RNTI. For example, the gNB 200 configures for the UE 100 association information (e.g., second association information) relating to the association between the first SPS configuration and the first CS-RNTI, and association information (e.g., third association information) relating to the association between the second SPS configuration and the second CS-RNTI.

In step S12, the gNB 200 transmits the configuration information to the UE 100. The gNB 200 may transmit an RRC message or a MAC CE including the configuration information to the UE 100. The configuration information includes the plurality of SPS configurations configured in step S10 and the association information configured in step S11. The configuration information may be transmitted as configuration information in which the SPS configuration in step S10 and the association information configured in step S11 are different using separate (or different types of) messages. The configuration information may include association information of each SPS configuration and each CS-RNTI. The configuration information may be transmitted as configuration information in which the association information and the configuration information transmitted in step S12 are different using separate (or different types of) messages.

In step S13, the UE 100 monitors a PDCCH in accordance with the periodicity of each SPS configuration in response to reception of the configuration information.

In step S14, the UE 100 determines that radio resource allocation using the PDCCH received at the periodicity of each SPS is valid. For example, it is assumed that the first SPS configuration of the index #1 and the second SPS configuration of the index #2 are associated. In this case, the UE 100 performs, for example, the following processing.

That is, when succeeding in descrambling first DCI included in the first PDCCH using the CS-RNTI included in the configuration information with respect to the first PDCCH monitored at a reception timing of the first periodicity indicated by the first SPS configuration, the UE 100 recognizes that the radio resource allocation that uses the first DCI has occurred. That is, when succeeding in descrambling second DCI included in the second PDCCH using the CS-RNTI included in the configuration information with respect to the second PDCCH monitored at a reception timing of the second periodicity indicated by the second SPS configuration, the UE 100 recognizes that the radio resource allocation that uses the second DCI has occurred. When recognizing the occurrence of these two radio resource allocations, the UE 100 determines that the two radio resource allocations are valid. Here, the first SPS configuration and the second SPS configuration are associated. Hence, when recognizing that the radio resource allocation that uses the first DCI has occurred, the UE 100 may recognize that radio resource allocation has occurred at the first periodicity and the second periodicity. When recognizing that radio resource allocation that uses the second DCI has occurred, the UE 100 may recognize that radio resource allocation has occurred at the first periodicity and the second periodicity.

Note that, in a case of the unassociated third SPS configuration of the index #3, when succeeding in descrambling third DCI included in a third PDCCH using the CS-RNTI included in the configuration information with respect to the third PDCCH monitored at a reception timing of the third periodicity indicated by the third SPS configuration, the UE 100 recognizes that the radio resource allocation that uses the third DCI is valid.

When further receiving the association information in which each SPS configuration and each CS-RNTI are associated, the UE 100 determines that the resource allocation that uses each PDCCH descrambled using each CS-RNTI is valid. For example, it is assumed that the first SPS configuration and the second SPS configuration are associated, the first SPS configuration and the first CS-RNTI are associated, and the second SPS configuration and the second CS-RNTI are associated. In this case, the UE 100 performs, for example, the following processing. That is, when performing monitoring at the reception timing of the first periodicity indicated by the first SPS configuration, and succeeding in descrambling third DCI included in the third PDCCH using the first CS-RNTI, the UE 100 recognizes the radio resource allocation that uses the third DCI. When performing monitoring at the reception timing of the second periodicity indicated by the second SPS configuration, and succeeding in descrambling fourth DCI included in a fourth PDCCH using the second CS-RNTI, the UE 100 recognizes the radio resource allocation that uses the fourth DCI. When recognizing these two radio resource allocations, the UE 100 determines that the two radio resource allocations are valid. It is assumed that the first SPS configuration and the second SPS configuration are associated, and the first SPS configuration and the second CS-RNTI are associated with a fifth CS-RNTI. That is, it is assumed that the two SPS configurations are associated with the one CS-RNTI. In this case, when performing monitoring at the reception timings of the first periodicity indicated by the first SPS configuration and the second periodicity indicated by the second SPS configuration, and succeeding in descrambling fifth DCI included in a fifth PDCCH using the fifth CS-RNTI, the UE 100 may recognize the radio resource allocation that uses the fifth DCI.

In step S15, the UE 100 receives a PDSCH in accordance with a periodicity of each SPS configuration. For example, the UE 100 receives the first PDSCH using the radio resources of the first DCI per first periodicity, and receives the second PDSCH using the radio resources of the second DCI per second periodicity. For example, the UE 100 receives the third PDSCH using the radio resources of the third DCI per first periodicity, and receives the fourth PDSCH using the radio resources of the fourth DCI per second periodicity. The UE 100 may receive the fifth PDSCH using radio resources of the fifth DCI per first periodicity and per second periodicity.

### Variation of First Embodiment

In the first embodiment, the example of the SPS configuration has been described. For example, the first embodiment may be applied to the CG configuration.

That is, the gNB 200 configures a plurality of CG configurations having different periodicities for the UE 100 (step S10). Next, the gNB 200 associates the plurality of CG configurations, and configures association information relating to the association for the UE 100 (step S11 and step S12). For example, the gNB 200 associates (the index #1 of) the first CG configuration and (the index #2 of) the second CG configuration having different periodicities, and transmits, to the UE 100, association information (e.g., first association information) relating to the association between the first CG configuration and the second CG configuration.

Note that the gNB 200 may further associate each CG configuration and each CS-RNTI. For example, the gNB 200 associates the first CG configuration and the first CS-RNTI, and associates the second CG configuration and the second CS-RNTI. The gNB 200 transmits, to the UE 100, association information (e.g., second association information) relating to the association between the first CG configuration and the first CG-RNTI, and association information (e.g., third association information) relating to the association between the second CG configuration and the second CS-RNTI.

The UE 100 monitors a PDCCH in accordance with a periodicity of each CG configuration (step S13), and determines that the radio resource allocation that uses each PDCCH is valid (step S14). For example, it is assumed that the first CG configuration and the second CG configuration are associated. In this case, the UE 100 performs, for example, the following processing. That is, when succeeding in descrambling the first DCI included in the first PDCCH using the CS-RNTI with respect to the first PDCCH monitored at the reception timing of the first periodicity indicated by the first CG configuration, the UE 100 recognizes that the radio resource allocation that uses the first DCI has occurred. That is, when succeeding in descrambling the second DCI included in the second PDCCH using the CS-RNTI with respect to the second PDCCH monitored at the reception timing of the second periodicity indicated by the second CG configuration, the UE 100 recognizes that the radio resource allocation that uses the second DCI has occurred. When recognizing the occurrence of these two radio resource allocations, the UE 100 determines that the two radio resource allocations are valid.

For example, the UE 100 transmits a Physical Uplink Shared Channel (PUSCH) in accordance with the periodicity of each CG configuration (step S15). For example, the UE 100 transmits the first PUSCH using the radio resources of the first DCI per first periodicity indicated by the first CG configuration, and transmits the second PUSCH using the radio resources of the second DCI per second periodicity indicated by the second CG configuration.

When each CG configuration and each CS-RNTI are associated, for example, the following is assumed. That is, it is assumed that the first CG configuration and the second CG configuration are associated, the first CG configuration and the first CS-RNTI are associated, and the second CG configuration and the second CS-RNTI are associated. In this case, the UE 100 performs, for example, the following processing. That is, when monitoring the third PDCCH at the reception timing of the first periodicity indicated by the first CG configuration, and succeeding in descrambling the third DCI included in the third PDCCH using the first CS-RNTI, the UE 100 recognizes the radio resource allocation that uses the third DCI. When performing monitoring at the reception timing of the second periodicity indicated by the second CG configuration, and succeeding in descrambling the fourth DCI included in the fourth PDCCH using the second CS-RNTI, the UE 100 recognizes the radio resource allocation that uses the fourth DCI. When recognizing these two radio resource allocations, the UE 100 determines that the two radio resource allocations are valid. For example, the UE 100 transmits a third PUSCH using the radio resources of the third DCI per first periodicity indicated by the first CG configuration, and transmits a fourth PUSCH using the radio resources of the fourth DCI per second periodicity indicated by the second CG configuration. For example, it is assumed that the first CG configuration and the second CG configuration are associated, and the first CG configuration and the second CG configuration are associated with the fifth CS-RNTI. That is, it is assumed that one CS-RNTI is associated with two CG configurations. In this case, when performing monitoring at the reception timings of the first periodicity indicated by the first SPS configuration and the second periodicity indicated by the second SPS configuration, and succeeding in descrambling the fifth DCI included in the fifth PDCCH using the fifth CS-RNTI, the UE 100 may recognize the radio resource allocation that uses the fifth DCI. The UE 100 may transmit the fifth PUSCH using radio resources of the fifth DCI per first periodicity and per second periodicity.

### Second Embodiment

A second embodiment will be described.

The following case is assumed for the CG configuration. That is, there is no particular problem when, as illustrated in FIG. 7A, for example, a periodicity of traffic received from the application layer in the AS of the UE 100, and a periodicity indicated by the CG configuration match, and the timing to receive the traffic from the application layer and a transmission timing permitted by the CG configuration match.

However, it is assumed that, as illustrated in FIG. 7B, while a periodicity of traffic received from the application layer and a periodicity indicated by a CG configuration match, a timing to receive the traffic from the application layer is different from a transmission timing permitted by the CG configuration. In this case, the UE 100 performs packet transmission based on the CG configuration at a timing delayed from the timing at which the traffic has been received from the application layer. Therefore, the transmission timing of the traffic transmitted from the UE 100 is delayed, and the delay may become transmission delay. The transmission delay may not necessarily be preferable as a User experience (UX) of a user who uses the UE 100 (or the XR device).

Although FIGS. 7A and 7B illustrate examples of the CG configurations, the same applies to the case of the SPS configurations. That is, when a timing at which the UE 100 receives traffic from the gNB 200 and a timing at which the AS of the gNB 200 outputs the received traffic to the application layer do not match, transmission delay (or processing delay) may occur. Alternatively, when traffic received by the gNB 200 from the 5GC 20 (e.g., UPF 300) and an SPS transmission timing do not match, transmission delay (or processing delay) may occur. Such transmission delay may not necessarily be preferable as a user experience, either.

Accordingly, even according to either the CG configuration or the SPS configuration, communication that uses XR may not necessarily be appropriately performed.

Hence, in the second embodiment, firstly, a base station (e.g., gNB 200) configures the SPS configuration or the CG configuration for a user equipment (e.g., UE 100). Secondly, the base station transmits to the user equipment a timing adjustment command for adjusting a start timing of a periodicity indicated by the SPS configuration or the CG configuration.

Thus, for example, the AS of the UE 100 can adjust the start timing of the periodicity indicated by the CG configuration to match with the timing at which the traffic has been received from the application layer. For example, the AS of the UE 100 can adjust the start timing of the periodicity indicated by the SPS configuration to match with a timing to output the traffic to the application layer. Accordingly, transmission delay is suppressed, and the mobile communication system 1 can appropriately perform communication that uses XR.

### Operation Example of Second Embodiment

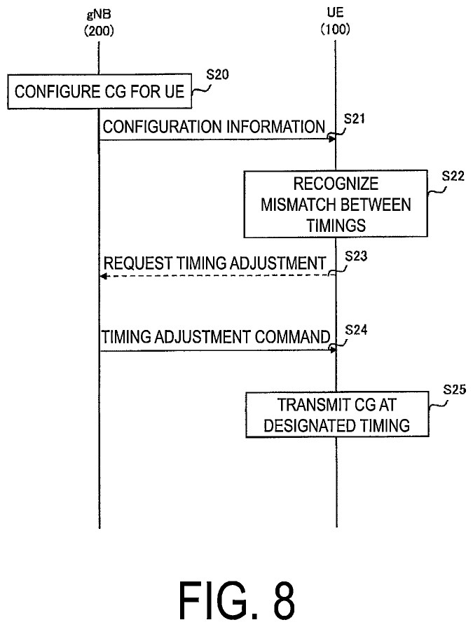

FIG. 8 is a diagram illustrating an operation example according to the second embodiment. In this regard, FIG. 8 illustrates an example of a CG configuration. First, an example of the CG configuration will be described.

As illustrated in FIG. 8, the gNB 200 configures the CG configuration for the UE 100 in step S20.

In step S21, the gNB 200 transmits configuration information including the CG configuration to the UE 100. The gNB 200 may transmit the configuration information using an RRC message, a MAC CE, or the like.

In step S22, the AS of UE 100 recognizes that there is mismatch between a timing to receive a packet from the application layer (or the NAS layer) and a transmission timing of the packet permitted by the CG configuration.

When recognizing that there is a mismatch, the UE 100 may request a timing adjustment from the gNB 200 (step 23). The UE 100 may make the request by transmitting a

MAC CE or DCI including the request to the gNB 200. The request may include difference information indicating a difference between a timing at which the AS of the UE 100 receives a packet from the application layer (or a NAS layer) and a transmission timing of the packet permitted by the CG configuration. The difference information may include the information indicating the timing difference, and, in addition, a direction in the time domain in which the difference is produced (e.g., information indicating whether to make the transmission timing of the packet permitted by the CG configuration earlier or later than a current configuration value).

In step S24, the gNB 200 transmits the timing adjustment command to the UE 100. The timing adjustment command is, for example, a command for adjusting the start timing of the periodicity indicated by the CG configuration. The timing adjustment command includes, for example, following information.

That is, the timing adjustment command includes information for designating a start timing to monitor a PDCCH next. The periodicity indicated by the CG configuration may be also a periodicity to monitor a PDCCH. Hence, the timing adjustment command includes, for example, information on the timing to start monitoring the PDCCH. The information on the start timing may be information for designating a slot that is n slots after a current slot. Alternatively, the information on the start timing may be information that indicates a difference (±n slots) from the start timing (or the next start timing) of the periodicity indicated by the CG configuration to a start timing after the timing adjustment. The unit of the start timing may be represented by a subframe, msec, or the like in addition to a slot.

When receiving the timing adjustment request (step S23) from the UE 100, the gNB 200 may transmit the timing adjustment command in response to reception of the request. In this case, the timing adjustment command may include a start timing corresponding to difference information indicating a difference between a timing at which the AS of the UE 100 receives a packet from the application layer (or a NAS layer) and a transmission timing of the packet permitted by the CG configuration.

Note that the gNB 200 may transmit the timing adjustment command to the UE 100 by transmitting a MAC CE or DCI including the timing adjustment command to the UE 100.

In step S25, in response to reception of the timing adjustment command, the UE 100 continues transmitting a PUSCH at the periodicity indicated by the CG configuration (step S20) starting from the start timing designated by the timing adjustment command.

### Variation of Second Embodiment

In the first embodiment, the timing adjustment command for the CG configuration has been described. However, the present disclosure is not limited thereto.

For example, a timing adjustment command for the SPS configuration may be transmitted from the gNB 200 to the UE 100 (step S24). In this case, the gNB 200 transmits to the UE 100 the timing adjustment command for adjusting the start timing of the periodicity indicated by the SPS configuration (step S20) (step S24). The information itself included in the timing adjustment command may be the same as that in the first embodiment. The gNB 200 monitors a PDCCH at the timing designated by the timing adjustment command, receives a PDSCH using radio resources included in the PDCCH, and then continues receiving the PDSCH at the periodicity indicated by the SPS configuration (step S25).

For example, a timing adjustment command for a DRX configuration may be transmitted from the gNB 200 to the UE 100 (step S24). In this case, the timing adjustment command includes, for example, information for designating a start timing of an on duration (i.e., the start timing of onDurationTimer) in the DRX configuration (step S20). The UE 100 starts receiving the PDSCH at the designated timing (step S25).

### Other Embodiments

A program causing a computer to execute each of the processing performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM and/or a DVD-ROM.

Circuits for executing processing performed by the UE 100 or the gNB 200 may be integrated, and at least a part of the UE 100 or the gNB 200 may be implemented as a semiconductor integrated circuit (chipset, system on a chip (SoC)).

Embodiments have been described above in detail with reference to the drawings, but specific configurations are not limited to those described above, and various design variation can be made without departing from the gist of the present disclosure. All or some of the embodiments, operations, processes, and steps may be combined without being inconsistent.

The phrases “based on” and “depending on” used in the present disclosure do not mean “based only on” and “only depending on,” unless specifically stated otherwise. The phrase “based on” means both “based only on” and “based at least in part on”. The phrase “depending on” means both “only depending on” and “at least partially depending on”. “Obtain” or “acquire” may mean to obtain information from stored information, may mean to obtain information from information received from another node, or may mean to obtain information by generating the information. The terms “include”, “comprise” and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

### Supplementary Note

According to one embodiment, (Supplementary Note 1) a communication control method in a mobile communication system includes: performing, at a base station, one of associating a first Semi-Persistent Scheduling (SPS) configuration and a second SPS configuration having different periodicities or associating a first Configured Grant (CG) configuration and a second

CG configuration having different periodicities; and transmitting, at the base station, first association information to a user equipment, the first association information relating to one of the association between the first SPS configuration and the second SPS configuration or the association between the first CG configuration and the second CG configuration.

(Supplementary Note 2) The communication control method according to above (Supplementary Note 1) can further include, at the user equipment: receiving a first Physical Downlink Shared CHannel (PDSCH) or transmitting a first Physical Uplink Shared CHannel (PUSCH) using, per first periodicity, a first radio resource included in a first Physical Downlink Control CHannel (PDCCH) received at a reception timing of the first periodicity indicated by the first SPS configuration or the first CG configuration; and receiving a second PDSCH or transmitting a second PUSCH using, per second periodicity, a second radio resource included in a second PDCCH received at a reception timing of the second periodicity indicated by the second SPS configuration or the second CG configuration.

(Supplementary Note 3) In the communication control method according to above (Supplementary Note 1) or (Supplementary Note 2), the associating can include, at the base station, one of:
associating the first SPS configuration and a first Configured Scheduling Radio Network Temporary Identifier (CS-RNTI), and associating the second SPS configuration and the second CS-RNTI; or associating the first CG configuration and the first CS-RNTI, and associating the second CG configuration and the second CS-RNTI, and the transmitting can include transmitting, at the base station, second association information and third association information to the user equipment, the second association information relating to the association between the first CS-RNTI and one of the first SPS configuration and the first CG configuration, and the third association information relating to the association between the second CS-RNTI and one of the second SPS configuration and the second CG configuration.

According to one embodiment, (Supplementary Note 4) a communication control method in a mobile communication system includes: configuring, at a base station, an SPS configuration or a CG configuration for a user equipment; and transmitting, at the base station to the user equipment, a timing adjustment command for adjusting a start timing of a periodicity indicated by the SPS configuration or the CG configuration.

(Supplementary Note 5) According to the communication control method according to above (Supplementary Note 4), the start timing is a timing at which monitoring a PDCCH in the user equipment starts.

(Supplementary Note 6) The communication control method according to above (Supplementary Note 4) or (Supplementary Note 5) can further include requesting, at the user equipment, adjustment of the reception timing or the transmission timing from the base station, and the transmitting of the timing adjustment command includes transmitting, at the base station, the timing adjustment command to the user equipment in response to reception of the request.

### REFERENCE SIGNS

1: Mobile communication system
20: CN
100: UE
110: Receiver
120: Transmitter
130: Controller
200: gNB
210: Transmitter
220: Receiver
230: Controller
300: AMF

1. A communication control method in a mobile communication system comprising the steps of:
performing, at a network node, one of associating a first Semi-Persistent Scheduling (SPS) configuration and a second SPS configuration having different periodicities or associating a first Configured Grant (CG) configuration and a second CG configuration having different periodicities; and
transmitting, at the network node, first association information to a user equipment, the first association information relating to one of the association between the first SPS configuration and the second SPS configuration or the association between the first CG configuration and the second CG configuration.

2. The communication control method according to claim 1, further comprising the steps of, at the user equipment:
receiving a first Physical Downlink Shared CHannel (PDSCH) or transmitting a first Physical Uplink Shared CHannel (PUSCH) using, per first periodicity, a first radio resource comprised in a first Physical Downlink Control CHannel (PDCCH) received at a reception timing of the first periodicity indicated by the first SPS configuration or the first CG configuration; and
receiving a second PDSCH or transmitting a second PUSCH using, per second periodicity, a second radio resource comprised in a second PDCCH received at a reception timing of the second periodicity indicated by the second SPS configuration or the second CG configuration.

3. The communication control method according to claim 1, wherein
the associating comprises, at the network node, one of:
associating the first SPS configuration and a first Configured Scheduling Radio Network Temporary Identifier (CS-RNTI), and associating the second SPS configuration and a second CS-RNTI; or
associating the first CG configuration and the first CS-RNTI, and associating the second CG configuration and the second CS-RNTI, and
the transmitting comprises transmitting, at the network node, second association information and third association information to the user equipment, the second association information relating to the association between the first CS-RNTI and one of the first SPS configuration or the first CG configuration, and the third association information relating to the association between the second CS-RNTI and one of the second SPS configuration or the second CG configuration.

4. A communication control method in a mobile communication system comprising the steps of:
configuring, at a network node, an SPS configuration or a CG configuration for a user equipment; and
transmitting, at the network node to the user equipment, a timing adjustment command configured to adjust a start timing of a periodicity indicated by the SPS configuration or the CG configuration.

5. The communication control method according to claim 4, wherein the start timing is a timing at which monitoring a PDCCH in the user equipment starts.

6. The communication control method according to claim 4, further comprising requesting, at the user equipment, a timing adjustment from the network node,
wherein the transmitting of the timing adjustment command comprises transmitting, at the network node, the timing adjustment command to the user equipment in response to reception of the request.

7. A network node comprising:
a controller configured to perform one of associating a first Semi-Persistent Scheduling (SPS) configuration and a second SPS configuration having different periodicities or associating a first Configured Grant (CG) configuration and a second CG configuration having different periodicities; and
a transmitter configured to transmit first association information to a user equipment, the first association information relating to one of the association between the first SPS configuration and the second SPS configuration or the association between the first CG configuration and the second CG configuration.
